(19) United States
(12) Patent Application Publication
(10) Pub. No.: US 2014/0378176 A1
(43) Pub. Date: Dec. 25, 2014

(54) METHOD, APPARATUS AND SYSTEM FOR SHORT MESSAGE-BASED INFORMATION PUSH AND MOBILE CLIENT SUPPORTING THE SAME

(71) Applicant: TENCENT TECHNOLOGY (SHENZHEN) COMPANY LIMITED, Shenzhen (CN)

(72) Inventor: Jing Ning, Shenzhen (CN)

(73) Assignee: TENCENT TECHNOLOGY (SHENZHEN) COMPANY LIMITED, Shenzhen (CN)

(21) Appl. No.: 14/483,624

(22) Filed: Sep. 11, 2014

Related U.S. Application Data
(63) Continuation of application No. PCT/CN2013/090516, filed on Dec. 26, 2013.

(30) Foreign Application Priority Data
Jun. 9, 2013 (CN) 201310231275.1

(51) Int. Cl. H04W 4/14

(52) U.S. Cl. CPC H04W 4/14; H04L 67/26
USPC 455/466

(57) ABSTRACT

A method, apparatus and system for short message-based information push and mobile client supporting the same are disclosed. The method includes: acquiring information to be pushed on an application server; generating a short message based on the information to be pushed when a mobile client is determined to be offline; and pushing the short message to the mobile client. According to the above method, apparatus and system for short message-based information push and mobile client supporting the same, push information in the form of short message to a mobile client when the mobile client is offline, and do not need additional wakeup mechanism for sending a heartbeat packet from the client to the server due to short message push, which reduces the number of times of waking up the mobile client and saves the electric power of the mobile client.

### CROSS REFERENCE TO RELATED APPLICATIONS

This application is a continuation application of the PCT International Application No. PCT/CN2013/090516, filed on Dec. 26, 2013, entitled “METHOD, APPARATUS AND SYSTEM FOR SHORT MESSAGE-BASED INFORMATION PUSH AND MOBILE CLIENT SUPPORTING THE SAME” by Jing NING, which claims the priority from Chinese Patent Application No. 201310231275.1, filed on Jun. 9, 2013. The above-referenced applications are incorporated by reference herein in their entirety for all purposes.

### FIELD OF THE INVENTION

The present disclosure relates generally to the field of push technology, and more particularly, to a method, apparatus, system and computer-readable storage medium for short message-based information push and a mobile client supporting the same.

### BACKGROUND OF THE INVENTION

On the current Internet-based communication, there are two ways for obtaining updated information from a server. The first way is information pull, where a request for a transmission of information is initiated by a client. The other way is information push, where a request for a given transaction is initiated by a server. In the telecommunication system, compared with the information pull, the information push can reduce network traffic and power consumption on the client.

In the existing information push system, a push channel between the server and the client should be established for transmitting information after the client connected with the server by network, but when the base band is idle over a period of time the push channel will be disconnected, so that the information to be pushed cannot be received by the client in time. To solve this problem, a heartbeat packet is normally sent from the client to the server at intervals to maintain the push channel. In mobile practical applications, the sending of the heartbeat packet for maintaining the communication link between the client and the server will wake up the mobile phone from standby, and the high frequency of such operation will consume a lot of electric power at the client terminal, which will become increasingly worse if every application with information push in the mobile client needs to send a heartbeat packet out to the server at intervals. Furthermore, the conventional information push technology may also cause signaling pressure to the infrastructure of mobile operator, due to a mass of push channels to be maintained.

It follows that the conventional information push wastes a lot of electric power in the mobile client and a lot of communication resource, especially when the mobile client is ideal, and when the cellular data network is congested that the push channel cannot be established, the information to be pushed cannot be received by the client.

### SUMMARY OF THE INVENTION

In view of the above, an object of the present disclosure is to provide a method, apparatus, system and computer-readable storage medium for short message-based information push and a mobile client supporting the same, which can reduce power consumption and communication resource consumption.

According to one aspect of the disclosure, a method for short message-based information push includes the steps of:

acquiring information to be pushed on an application server;

generating a short message based on the information to be pushed when a mobile client is determined to be offline; and

pushing the short message to the mobile client.

According to a further aspect of the disclosure, an apparatus for short message-based information push includes:

an acquisition module, configured to acquire information to be pushed on an application server;

a generation module, configured to generate a short message based on the information to be pushed when a mobile client is determined to be offline; and

a push module, configured to push the short message to the mobile client.

According to a further aspect of the disclosure, a system for short message-based information push includes:

an application server, configured to acquire information to be pushed; and

a short message push server, configured to generate a short message based on the information to be pushed when a mobile client is determined to be offline, and push the short message to the mobile client.

According to another further aspect of the disclosure, a mobile client includes:

an intercept and parse module, configured to intercept the short message and parse the short message to obtain pushed information; and

a display module, configured to display corresponding to the information in accordance with a user's setting.

According to still a further aspect of the disclosure, a non-transitory computer-readable storage medium comprising an executable program to execute a method for short message-based information push is provided. The method includes the steps of:

acquiring information to be pushed on an application server;

generating a short message based on the information to be pushed when a mobile client is determined to be offline; and

pushing the short message to the mobile client.

According to the above method, apparatus, system and non-transitory computer-readable storage medium for short message-based information push and mobile client supporting the same, information is pushed in the form of short message to a mobile client when the mobile client is offline. An additional wakeup mechanism for sending a heartbeat packet from the client to the server is not necessary due to the short message push, which reduces the number of times of waking up the mobile client and saves the electric power of the mobile client. In addition, it can avoid increasing the signaling burden led by installing multiple applications in the mobile client that saves communication resource, and the instant information push can be guaranteed.

### BRIEF DESCRIPTION OF THE DRAWINGS

The accompanying drawings illustrate one or more embodiments of the disclosure and together with the written description, serve to explain the principles of the disclosure. Wherever possible, the same reference numbers are used throughout the drawings to refer to the same or like elements of an embodiment.

FIG. 1 is a flow diagram illustrating a method for short message-based information push according to one embodiment of the present disclosure.

FIG. 2 is a flow diagram illustrating a method for short message-based information push according to one embodiment of the present disclosure.

FIG. 3 is a structure diagram illustrating an apparatus for short message-based information push according to one embodiment of the present disclosure.

FIG. 4 is a structure diagram illustrating an apparatus for short message-based information push according to another embodiment of the present disclosure.

FIG. 5 is a structure diagram illustrating an apparatus for short message-based information push according to a further embodiment of the present disclosure.

FIG. 6 is a structure diagram illustrating a system for short message-based information push according to one embodiment of the present disclosure.

FIG. 7 is a structure diagram illustrating a system for short message-based information push according to another embodiment of the present disclosure.

FIG. 8 is a structure diagram illustrating a mobile client according to one embodiment of the present disclosure.

FIG. 9 is a structure diagram illustrating a mobile client according to another embodiment of the present disclosure.

FIG. 10 is a structure diagram illustrating a mobile client according to a further embodiment of the present disclosure.

### DETAILED DESCRIPTION OF THE INVENTION

In the following description of embodiments, reference is made to the accompanying drawings which form a part hereof, and in which it is shown by way of illustration specific embodiments of the disclosure that can be practiced. It is to be understood that other embodiments can be used and structural changes can be made without departing from the scope of the disclosed embodiments.

As shown in FIG. 1, in one embodiment of the present disclosure, a method for short message-based information push includes:

Step S102, acquiring information to be pushed on an application server.

Specifically, when an application developer updates function of an application, there will be new information that is stored in a server of the application as information to be pushed to a client. For example, update the application WeChat, and the new information may be program code for fixing bug.

Step S104, generating a short message based on the information to be pushed when a mobile client is determined to be offline.

Specifically, whether a mobile client is offline or online can be determined by detecting whether the mobile client is in normal communication with the server. For example, send information to an existing connection from the application server, if there is a response from the mobile client, it shows that the mobile client is online, or if there is no response from the mobile client, it shows that the mobile client is offline.

The information to be pushed may be numbers of subscriber identity module (SIM) in the mobile client, information source or descriptive information of the application. The mobile client may be a client that a SIM card can be inserted, such as smart phone, tablet computer that a SIM card can be inserted. The information source refers to a source of information to be pushed of the application. The descriptive information of the application refers to a function introduction or updated content about the application. The format of the short message may be in the encrypted structured data format.

Step S106, pushing the short message to the mobile client.

Specifically, push the short message to the mobile client corresponding to the user identification number.

In addition, it needs to apply to a short message push server for an account in advance, when information is to be pushed by the application server by way of short message.

The above method for short message-based information push pushes information in the form of short message to a mobile client when the mobile client is offline, and does not need additional wakeup mechanism for sending a heartbeat packet from the client to the server due to short message push, which reduces the number of times of waking up the mobile client and saves the electric power of the mobile client, in addition, it can avoid increasing signaling burden led by installing multiple application in the mobile client that saves communication resource, and the instant information push can be guaranteed.

Further, in one embodiment of the present disclosure, the above method for short message-based information push also includes:

pushing the information to be pushed to the mobile client directly on line when the mobile client is determined to be online.

Specifically, if the mobile client is determined to be online, push the information to be pushed to the mobile client directly on line, instead of sending by short message, to save communication resource.

Further, in another embodiment of the present disclosure, as shown in FIG. 2, the method for short message-based information push adds a process of pushing information in the mobile client compared with the method in FIG. 1. The method for short message-based information push includes the following steps.

Step S202, acquiring information to be pushed on an application server.

Step S204, generating a short message based on the information to be pushed when a mobile client is determined to be offline.

Step S206, pushing the short message to the mobile client.

Step S208, intercepting the short message in the mobile client, and obtaining the pushed information by parsing the short message.

Specifically, intercept the short message in the mobile client, parse the short message to obtain the information to be pushed, and delete the short message from the short message list.

Step S210, displaying corresponding to the information in accordance with a user's select setting.

Specifically, the user's select setting includes at least one of the following: whether to display pushed information of an application, number of pushed information to be displayed, accumulated value of pushed information to be displayed, and a period of time to be displayed. Whether to display pushed information of an application refers to certain pushed information can be preset to be masked, for example, preset to mask the upgrade information of Need for Speed. The number of pushed information to be displayed refers to setting the maximum number of pushed information that is capable of displaying, for example, the maximum number is 10 that a maximum of 10 pieces of pushed information can be displayed. The accumulated value of pushed information to be displayed refers to the pushed information cannot be displayed until the number of pushed information accumulated reaches a certain number. The period of time to be displayed refers to setting one specified time range that the pushed information can be displayed, for example, display the pushed information between 11:00 am and 2:00 pm every day. In addition, the user's select setting may include other select settings except the above.

For example, if the accumulated value is set to 10, the pushed information will be displayed on the display interface of the mobile client once the number of pushed information accumulated reaches 10.

The display format of pushed information may be the name of the application, information source: message digest. In addition, the icon and/or picture message of the application can also be displayed.

In addition, the pushed information may be displayed in the form of popup messagebox.

Further, in one embodiment of the present disclosure, the above method for short message-based information push also includes:

acquiring the pushed information selected by a user after the pushed information is displayed;

jumping to a corresponding application according to description information of the application in the pushed information; and

pulling real-time information to be pushed proactively form the corresponding application server, and showing it to the user.

The above method for short message-based information push can jump to a corresponding application according to description information of the application in the pushed information after pushed information is selected by a user, and pull real-time information to be pushed actively form the application server after the application is started. Because the mobile client works in active, electric power will not be wasted, and the mobile client can acquire pushed information immediately that information timeliness can be guaranteed.

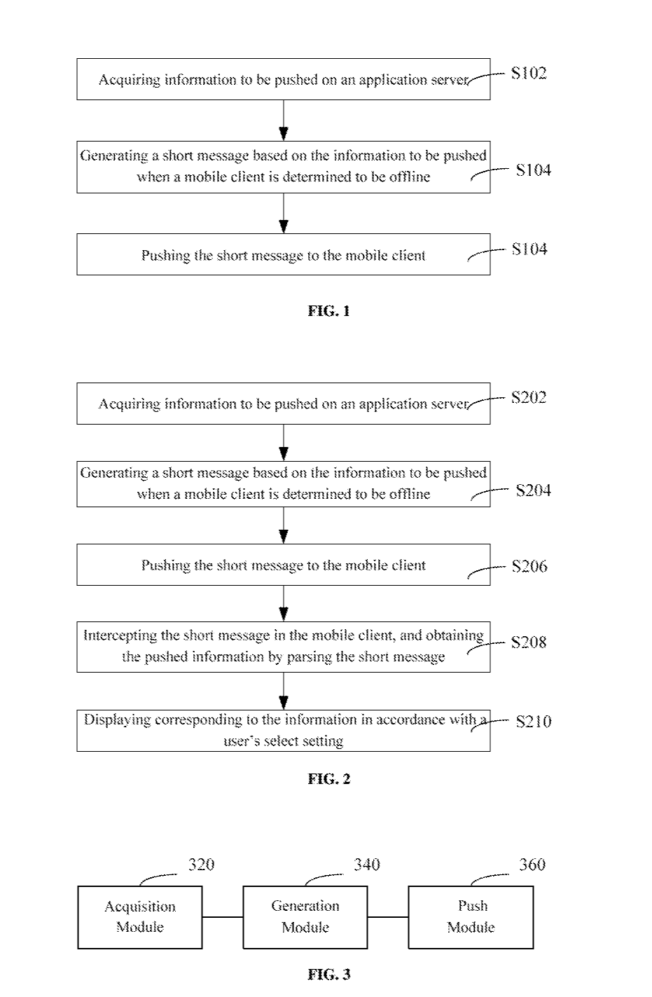

As shown in FIG. 3, in one embodiment of the present disclosure, an apparatus for short message-based information push includes an acquisition module 320, a generation module 340 and a push module 360.

The acquisition module 320 is configured to acquire information to be pushed on an application server.

Specifically, when an application developer updates function of an application, there will be new information that is stored in a server of the application as information to be pushed to a client. For example, update the application WeChat, and the new information may be program code for fixing bug. The acquisition module 320 is located on the application server.

The generation module 340 is configured to generate a short message based on the information to be pushed when a mobile client is determined to be offline.

Specifically, whether a mobile client is offline or online may be determined by detecting whether the mobile client is in normal communication with the server. For example, send information to an existing connection from the application server, if there is a response from the mobile client, it shows that the mobile client is online, or if there is no response from the mobile client, it shows that the mobile client is offline.

The information to be pushed may be numbers of subscriber identity module in the mobile client, information source or descriptive information of the application. The mobile client may be a client that a SIM card can be inserted, such as smart phone, tablet computer that a SIM card can be inserted. The information source refers to a source of information to be pushed of the application. The descriptive information of the application refers to a function introduction or updated content about the application. The format of the short message can be in the encrypted structured data format.

The push module 360 is configured to push the short message to the mobile client.

Specifically, push the short message to the mobile client corresponding to the user identification number.

The generation module 340 and push module 360 are located on the short message push server.

In addition, it needs to apply to a short message push server for an account in advance, when information is to be pushed by the application server by way of short message.

The above apparatus for short message-based information push pushes information in the form of short message to a mobile client when the mobile client is offline, and does not need additional wakeup mechanism for sending a heartbeat packet from the client to the server due to short message push, which reduces the number of times of waking up the mobile client and saves the electric power of the mobile client, in addition, it can avoid increasing signaling burden led by installing multiple application in the mobile client that saves communication resource, and the instant information push can be guaranteed.

Further, the push module 360 is also configured to push the information to be pushed to the mobile client directly on line when the mobile client is determined to be online. Specifically, if the mobile client is determined to be online, push the information to be pushed to the mobile client directly on line, instead of sending by short message, to save communication resource.

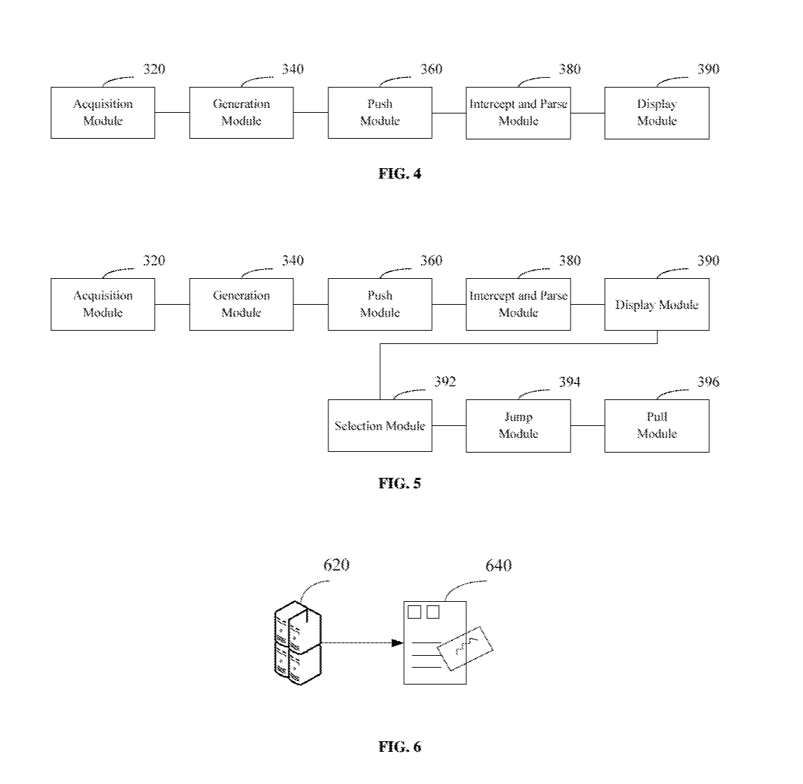

Further, in another embodiment of the present disclosure, as shown in FIG. 4, the apparatus for short message-based information push also includes an intercept and parse module 380 and a display module 390, in addition to the acquisition module 320, the generation module 340 and the push module 360.

The intercept and parse module 380 is configured to intercept the short message on the mobile client and parse the short message to obtain pushed information.

Specifically, the intercept and parse module 380 intercepts the short message in the mobile client, parses the short message to obtain pushed information, and deletes the short message from the short message list.

The display module 390 is configured to display corresponding to the information in accordance with a user's setting.

Specifically, the user's select setting includes at least one of the following: whether to display pushed information of an application, number of pushed information to be displayed, accumulated value of pushed information to be displayed, and a period of time to be displayed. Whether to display pushed information of an application refers to that certain pushed information can be preset to be masked, for example, preset to mask the upgrade information of Need for Speed that the information. The number of pushed information to be displayed refers to setting the maximum number of pushed information that is capable of displaying, for example, the maximum number is 10 that a maximum of 10 pieces of pushed information can be displayed. The accumulated value of pushed information to be displayed refers to the pushed information cannot be displayed until the number of pushed information accumulated reaches a certain number. The period of time to be displayed refers to setting one specified time range that the pushed information can be displayed, for example, display the pushed information between 11:00 am and 2:00 pm every day. In addition, the user's select setting can include other select settings except the above.

For example, if the accumulated value is set to 10, the pushed information will be displayed on the display interface of the mobile client once the number of pushed information accumulated reaches 10 pieces.

The display format of pushed information may be the name of the application, information source: message digest. In addition, the icon and/or picture message of the application may also be displayed.

Further, in one embodiment of the present disclosure, as shown in FIG. 5, the apparatus for short message-based information push also includes a selection module 392, a jump module 394 and a pull module 396, in addition to the acquisition module 320, the generation module 340, the push module 360, the intercept and parse module 380, and the display module 390.

The selection module 392 is configured to acquire the pushed information selected by a user after the pushed information is displayed.

The jump module 394 is configured to jump to a corresponding application according to description information of the application in the pushed information.

The pull module 396 is configured to pull real-time information to be pushed proactively form the corresponding application server, and show it to the user.

The above apparatus for short message-based information push may jump to a corresponding application according to description information of the application in the pushed information after pushed information is selected by a user, and pull real-time information to be pushed actively form the application server after the application is started. Because the mobile client works in active, electric power will not be wasted, and the mobile client can acquire pushed information immediately that information timeliness can be guaranteed.

Further, in one embodiment of the present disclosure, as shown in FIG. 6, a system for short message-based information push includes: an application server 620 and a short message push server 640.

The application server 620 is configured to acquire information to be pushed.

Specifically, when an application developer updates function of an application, there will be new information that is stored in the application server 620 as information to be pushed to a client. For example, update the application WeChat, and the new information may be program code for fixing bug.

The short message push server 640 is configured to generate a short message based on the information to be pushed when a mobile client is determined to be offline on the application server 620, and push the short message to the mobile client.

Specifically, whether a mobile client is offline or online may be determined on the application server 620 by detecting whether the mobile client is in normal communication with the application server 620.

The information to be pushed may be numbers of subscriber identity module in the mobile client, information source or descriptive information of the application. The mobile client may be a client that a SIM card can be inserted, such as smart phone, tablet computer that a SIM card can be inserted. The information source refers to a source of information to be pushed of the application. The descriptive information of the application refers to a function introduction or updated content about the application. The format of the short message can be in the encrypted structured data format.

The application server 620 is also configured to push the information to be pushed to the mobile client directly on line when the mobile client is determined to be online.

In addition, it needs to apply to the short message push server 640 for an account in advance, when information is to be pushed by the application server 620 by way of short message.

The above system for short message-based information push pushes information in the form of short message to a mobile client when the mobile client is offline, and does not need additional wakeup mechanism for sending a heartbeat packet from the client to the server due to short message push, which reduces the number of times of waking up the mobile client and saves the electric power of the mobile client, in addition, it can avoid increasing signaling burden led by installing multiple application in the mobile client that saves communication resource, and the instant information push can be guaranteed.

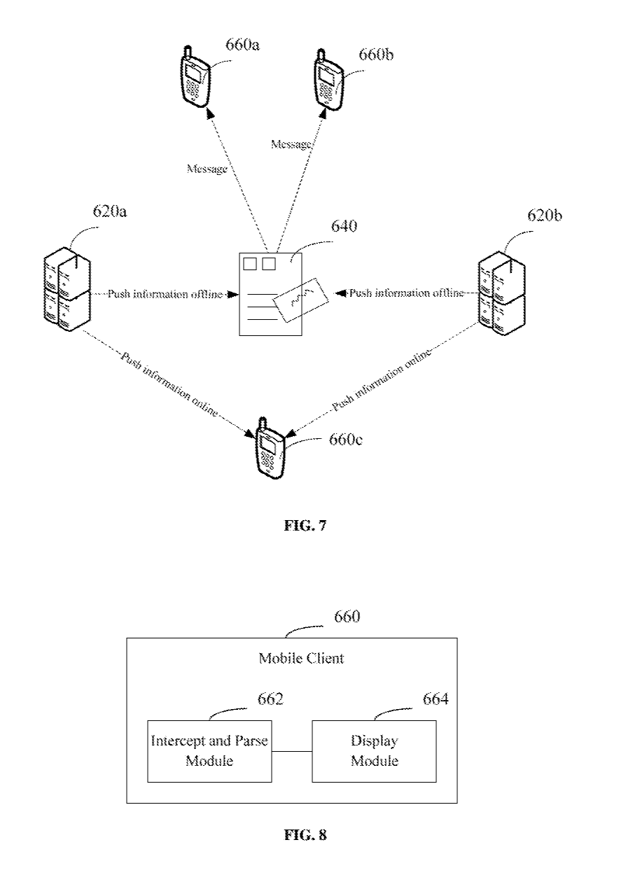

In another embodiment of the present disclosure, as shown in FIG. 7, the system for short message-based information push also includes a mobile client 660. The application server 620 includes an application server 620a and an application server 620b, and the mobile client 660 includes a mobile client 660a, a mobile client 660b and a mobile client 660c. The mobile clients 660a and 660b are offline and the mobile client 660c is online. The application server 620a and the application server 620b push respective information to be pushed to the mobile client 660c on line, and the application server 620a and the application server 620b push respective information to be pushed to the mobile client 660a and the mobile client 660b as short message by the short message push server 640.

The mobile client 660 is configured to intercept the short message, parse the short message to obtain the information to be pushed and display corresponding to the information in accordance with the user's setting.

Specifically, the user's select setting includes at least one of the following: whether to display pushed information of an application, number of pushed information to be displayed, accumulated value of pushed information to be displayed, and a period of time to be displayed. Whether to display pushed information of an application refers to certain pushed information can be preset to be masked, for example, preset to mask the upgrade information of Need for Speed that the information. The number of pushed information to be displayed refers to setting the maximum number of pushed information that is capable of displaying, for example, the maximum number is 10 that a maximum of 10 pieces of pushed information can be displayed. The accumulated value of pushed information to be displayed refers to the pushed information cannot be displayed until the number of pushed information accumulated reaches a certain number. The period of time to be displayed refers to setting one specified time range that the pushed information can be displayed, for example, display the pushed information between 11:00 am and 2:00 pm every day. In addition, the user's select setting can include other select settings except the above.

For example, if the accumulated value is set to 10, the pushed information will be displayed on the display interface of the mobile client once the number of pushed information accumulated reaches 10 pieces.

The display format of pushed information may be the name of the application, information source: message digest. In addition, the icon and/or picture message of the application may also be displayed.

In addition, the pushed information may be displayed in the form of popup messagebox.

Further, in one embodiment of the present disclosure, the mobile client 660 is also configured to acquire the pushed information selected by a user after the pushed information is displayed, jump to a corresponding application according to description information of the application in the pushed information, pull real-time information to be pushed proactively form the corresponding application server, and show it to the user.

As shown in FIG. 8, in one embodiment of the present disclosure, the mobile client 660 includes an intercept and parse module 662 and a display module 664.

The intercept and parse module 662 is configured to intercept the short message and parse the short message to obtain pushed information.

Specifically, the intercept and parse module 660 intercepts the short message in the mobile client, parses the short message to obtain pushed information, and deletes the short message from the short message list.

The display module 664 is configured to display corresponding to the information in accordance with user's setting.

Specifically, the user's select setting includes at least one of the following: whether to display pushed information of an application, number of pushed information to be displayed, accumulated value of pushed information to be displayed, and a period of time to be displayed. Whether to display pushed information of an application refers to certain pushed information can be preset to be masked , for example, preset to mask the upgrade information of Need for Speed. The number of pushed information to be displayed refers to setting the maximum number of pushed information that is capable of displaying, for example, the maximum number is 10 that a maximum of 10 pieces of pushed information can be displayed. The accumulated value of pushed information to be displayed refers to the pushed information cannot be displayed until the number of pushed information accumulated reaches a certain number. The period of time to be displayed refers to setting one specified time range that the pushed information can be displayed, for example, display the pushed information between 11:00 am and 2:00 pm every day. In addition, the user's select setting can include other select settings except the above.

For example, if the accumulated value is set to 10, the pushed information will be displayed on the display interface of the mobile client once the number of pushed information accumulated reaches 10 pieces.

The display format of pushed information may be the name of the application, information source: message digest. In addition, the icon and/or picture message of the application may also be displayed.

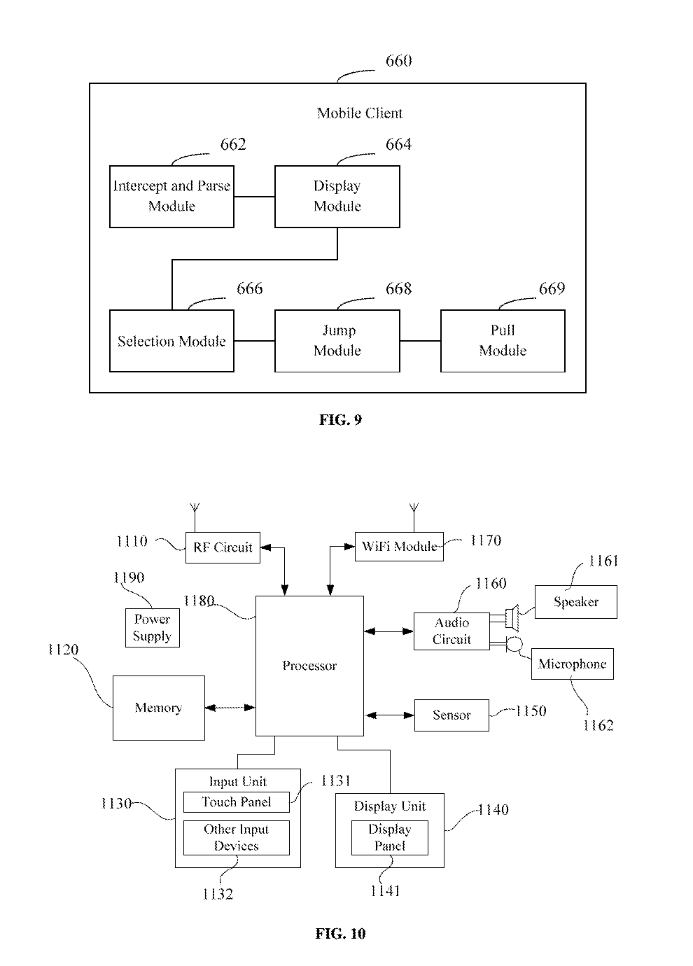

Further, in one embodiment of the present disclosure, as shown in FIG. 9, the mobile client 660 also includes a selection module 666, a jump module 668 and a pull module 669.

The selection module 666 is configured to acquire the pushed information selected by a user after the pushed information is displayed.

The jump module 668 is configured to jump to a corresponding application according to description information of the application in the pushed information.

The pull module 669 is configured to pull real-time information to be pushed proactively form the corresponding application server, and show it to the user.

The above mobile client may jump to a corresponding application according to description information of the application in the pushed information after pushed information is selected by the user, and pull real-time information to be pushed actively form the application server after the application is started. Because the mobile client works in active, electric power will not be wasted, and the mobile client can acquire pushed information immediately that information timeliness can be guaranteed.

It should be understood for a person skilled in the art that partial or full process to realize the methods in the above embodiments can be accomplished by related hardware instructed by a computer program, the program can be stored in a computer readable storage medium and the program can include the process of the embodiments of the above methods. Wherein, the storage medium can be a disk, a light disk, a Read-Only Memory or a Random Access Memory.

The above mobile client can be any mobile client device including mobile phone, tablet computer, personal digital assistant and CarPC. Take mobile phone as an example, in one embodiment of the present disclosure, as shown in FIG. 10, there is a hardware structure of the mobile client, for illustration purposes, only part of the hardware structure related to the present disclosure is shown, and technical details that are not shown please refer to the embodiments of the method of the present disclosure.

The mobile phone includes a radio frequency (RF) circuit 1110, a memory 1120, an input unit 1130, a display unit 1140, a sensor 1150, an audio circuit 1160, a wireless fidelity (WiFi) module 1170, a processor 1180 and a power supply 1190. It should be understood for a person skilled in the art that the mobile phone structure shown in FIG. 10 does not limit the mobile phone which may include more or less components than the components as shown, or a combination of the components, or has a different component layout.

Each component of the mobile phone can be best understood by reference to the following description taken in conjunction with FIG. 10.

The RF circuit 1110 is configured to receive and send information in the process of information transceiver or during a conversation. Specifically, the RF circuit 1110 receives downlink information from a base station, send the information to the processor 1180, and send uplink data to the base station. Generally, the RF circuit may include but is not limited to an antenna, one or more amplifier, a transceiver, a coupler, a low noise amplifier and a duplexer. In addition, the RF circuit 110 may communicate with other devices by wireless communication and network. The above wireless communication may use any communication standard or protocol which may include but is not limited to Global System of Mobile communication, General Packet Radio Service, Code Division Multiple Access, Wideband Code Division Multiple Access, Long Term Evolution, E-mail and Short Messaging Service.

The memory 1120 is configured to store software program and module, and the software program and module stored in the memory 1120 is run by the processor 1180 to execute various applications and data processing in the mobile phone. The memory 1120 may mainly includes a program memory area and an data memory area, wherein, the program memory area may be used to store operating system or an application that is needed by at least one function (such as sound playing or image playing), and the data memory area may be used to store data that created by using the mobile phone (such as audio data or phone book). In addition, the memory 1120 may include a high speed random access memory. Further, the memory 1120 may also include a nonvolatile memory device, for example, one or more disk memory, a Flash memory, or other nonvolatile memory devices.

The input unit 1130 is configured to receive a number or character Information from input, and generate a signal that is related to user setting and function control of the mobile phone 1100. Specifically, the input unit 1130 may include a touch panel 1131 and other input devices 1132. The touch panel 1131 is also know as a touch screen, which gathers touch operations on it or nearby (for example, the user uses a finger, a touch pen or any other suitable object or accessory to operate on the touch panel 1131 or nearby) and drive a corresponding connected device by preset program. Alternatively, the touch panel 1131 may include a touch detection device and a touch controller. The touch detection device is configured to detect the location touched by the user, detect a signal from a touch operation, and send the signal to the touch controller. The touch controller receive touch information from the touch detection device, convert the signal to a touch spot coordinate, send the coordinate to the processor 1180, and receive a command sent by the processor 1180 for executing. In addition, the touch panel 1131 may be implemented by resistance-type, capacitance-type, infrared ray or surface acoustic wave. Further, the input unit 1130 may also include other input devices 1132. Specifically, the other input devices 1132 may include but are not limited to a physical keyboard, a function key (such as a volume control key or a switch button), a trackball, a mouse or an action bar.

The display unit 1140 is configured to display information input by the user, information provided to the user and menus in the mobile phone. The display unit 1140 may include a display panel 1141. Alternatively, the display unit 1140 may be configured by a liquid crystal display an organic light-emitting diode. Further, the display panel 1141 may be covered by the touch panel 1131. When the touch panel 1131 detect a touch operation on it or nearby, information of the touch operation may be sent to the processor 1180 to determine the type of the touch operation, and the processor 1180 may provide corresponding visual output to the display panel 1141 to display according to the type of the touch operation. In FIG. 10, although the touch panel 1131 and the display panel 1141 are treated as two separate components to implement the input and output of the mobile phone, in same embodiments, the touch panel 1131 and the display panel 1141 may be integrated together to implement the input and output of the mobile phone.

The mobile phone 1100 also includes at least one sensor 1150, for example, an optical sensor, a motion sensor and other sensors. Specially, the optical sensor cam include an ambient light sensor or a proximity sensor, wherein the ambient light sensor is configured to adjust the brightness of the display panel 1141, and the proximity sensor is configured to close the display panel 1141 and/or backlight when the mobile moves close to a ear. As one kind of the motion sensors, the accelerometer sensor may measure accelerated speed in all directions (generally, three axes), and detect the direction and speed of gravity when the phone is static, so it can be used to identify a posture application in the mobile phone (such as screen rotation) or a vibration of the mobile phone for a corresponding function (such as a pedometer). Further the sensor 1150 may also include a gyroscope, a barometer, a hygrometer, a thermometer, a infrared sensor or other sensors.

The audio interface between the user and the mobile phone may be provided by an audio circuit 1160, a speaker 1161 and a microphone 1162. The audio circuit 1160 may transmit an electrical signal transformed from a received audio data to the speaker 1161, and the speaker 1161 transforms the electrical signal to an audio output after receiving the electrical signal. On the other hand, the microphone 1162 may transform collected audio information to electric signal, the audio circuit 1160 receives the electric signal and transforms it to audio data to output, the processor 1180 processes the audio data, and the processed audio data is sent to another mobile phone by the RF circuit 110, alternatively, the processed audio data may be sent to the memory 1120 for further processing.

WiFi is a short-range wireless communication technology. A mobile phone can help the user to use e-mail, browse the Web and access streaming media by the WiFi module 1170 which provides wireless broadband Internet access to the user. Understandably, although the WiFi module 1170 is shown in FIG. 10, it is not a necessary element of the mobile phone 1100, and it can be omitted as needed without departing from the scope of the present disclose.

The processor 1180 is the control center of the mobile phone, it is connected with all parts of the mobile phone by various interfaces and wires, and it performs various function and data processing of the mobile phone by running or executing software programs and/or modules stored in the memory 1120 and calling the data stored in the memory 1120, so as to control the whole mobile phone. Alternatively, the processor 1180 may include one or more processing units. Preferably, the processor 1180 may contain an application processor and a modem processor, wherein, the application processor mostly deals with an operating system, user interfaces and applications, and the modem processor mostly deals with wireless communication. It can be understood that the above modem processor also cannot be integrated in the processor 1180.

The mobile phone also includes a power supply 1190 that powers each component, for example, a battery. Preferably, the power supply may be connected with the processor 1180 by a power management system to implement battery charging, battery discharging and power management.

The mobile phone may also include a camera and a bluetooth module (not shown).

In the embodiment, the processor 1180 of the mobile phone is configured to intercept the short message, obtain the pushed information by parsing the short message and display corresponding to the information in accordance with the user's select setting.

The processor 1180 of the mobile phone is also configured to acquire the pushed information selected by the user after the pushed information is displayed, jump to a corresponding application according to description information of the application in the pushed information, pull real-time information to be pushed proactively form the corresponding application server, and show it to the user.

The above embodiments described are only several embodiments of the present disclosure, and they should not be understood as a limitation on the scope of the present disclosure. It should be noted that the modifications and variations could be made by the skilled in the art, which will be within the protection scope of the present disclosure. The protection scope of this disclosure is defined by the appending claims.

What is claimed is:

1. A method for short message-based information push, comprising:
acquiring information to be pushed on an application server;
generating a short message based on the information to be pushed when a mobile client is determined to be offline; and
pushing the short message to the mobile client.

2. The method according to claim 1, further comprising:
pushing the information to be pushed to the mobile client directly on line when the mobile client is determined to be online.

3. The method according to claim 1, further comprising:
intercepting the short message in the mobile client, and obtaining the information to be pushed by parsing the short message; and
displaying corresponding to the information in accordance with a user's select setting.

4. The method according to claim 3, wherein the user's select setting comprises at least one of: whether to display pushed information of an application, number of pushed information to be displayed, accumulated value of pushed information to be displayed, and a period of time to be displayed.

5. The method according to claim 1, wherein the information to be pushed comprises numbers of subscriber identity module in the mobile client, information source or descriptive information of the application.

6. An apparatus for short message-based information push, comprising:
an acquisition module, configured to acquire information to be pushed on an application server;
a generation module, configured to generate a short message based on the information to be pushed when a mobile client is determined to be offline; and
a push module, configured to push the short message to the mobile client.

7. The apparatus according to claim 6, wherein the push module is further configured to push the information to be pushed to the mobile client directly on line when the mobile client is determined to be online.

8. The apparatus according to claim 6, further comprising:
an intercept and parse module, configured to intercept the short message on the mobile client and parse the short message to obtain pushed information; and
a display module, configured to display corresponding to the information in accordance with a user's setting.

9. The apparatus according to claim 8, wherein the user's select setting comprises at least one of: whether to display pushed information of an application, number of pushed information to be displayed, accumulated value of pushed information to be displayed, and a period of time to be displayed.

10. The apparatus according to claim 6, wherein the information to be pushed comprises numbers of subscriber identity module in the mobile client, information source or descriptive information of the application.

11. A system for short message-based information push, comprising:
an application server, configured to acquire information to be pushed; and
a short message push server, configured to generate a short message based on the information to be pushed when a mobile client is determined to be offline, and push the short message to the mobile client.

12. The system according to claim 11, wherein the application server is further configured to push the information to be pushed to the mobile client directly on line when the mobile client is determined to be online.

13. The system according to claim 11, wherein the information to be pushed comprises numbers of subscriber identity module in the mobile client, information source or descriptive information of the application.

14. The system according to claim 11, further comprising:
a mobile client, configured to intercept the short message, parse the short message to obtain pushed information, and display corresponding to the information in accordance with a user's setting.

15. The system according to claim 11, wherein the user's select setting comprises at least one of: whether to display pushed information of an application, number of pushed information to be displayed, accumulated value of pushed information to be displayed, and a period of time to be displayed.

16. A mobile client, comprising:
an intercept and parse module, configured to intercept the short message and parse the short message to obtain pushed information; and
a display module, configured to display corresponding to the information in accordance with a user's setting.

17. The mobile client according to claim 16, wherein the user's select setting comprises at least one of: whether to display pushed information of an application, number of pushed information to be displayed, accumulated value of pushed information to be displayed, and a period of time to be displayed.
